(19) United States
(12) Patent Application Publication
(10) Pub. No.: US 2024/0411381 A1
(43) Pub. Date: Dec. 12, 2024

(54) Cushioning foot pad structure and keyboard

(71) Applicant: Shenzhen Drunk Deer Technology Co., Ltd., Shenzhen (CN)

(72) Inventor: Xuan Wang, Shenzhen (CN)

(21) Appl. No.: 18/632,947

(22) Filed: Apr. 11, 2024

(30) Foreign Application Priority Data
Jun. 8, 2023 (CN) 2023214480742

(51) Int. Cl. G06F 3/02

(52) U.S. Cl. CPC G06F 3/0202

(57) ABSTRACT

A cushioning foot pad structure and a keyboard, comprises an outer foot pad, a movable buckle, an elastic shock-absorbing block and an inner fixing board, wherein the outer foot pad and the movable buckle are sequentially placed in a groove of a main housing, the outer food pad is firmly attached to the movable buckle, and the movable buckle is flexibly fasten to the inner fixing plate, the elastic shock-absorbing block is installed between the movable buckle and the inner fixing plate, and the inner fixing plate is set inside the main housing.

### TECHNICAL FIELD

The present invention relates to the field of a foot pad, in particular to a cushioning foot pad structure and a keyboard.

### BACKGROUND TECHNOLOGY

For objects such as keyboards, wrist rests, desks, and chairs, typically silicone foot pads are provided on bottom portions thereof. Silicone foot pads, generally single-layer structures made of silicone rubber, are known for soft and elastic characteristics thereof, but lack of the function of adaptive height adjustment. When the objects mentioned above are placed on uneven surfaces (for example, tables and chairs placed on uneven ground), and needed to be flattened, conventional methods are to insert cardboard or the like into corners of tables to achieve heightening, and the height of the foot pads cannot be flexibly adjusted to achieve flattening.

### SUMMARY OF THE INVENTION

In view of the above defects in the prior art, the technical problem to be solved by the present invention is how to provide a foot pad structure that can adaptively adjust the height position, and the specific technical solutions are as follows:

A cushioning foot pad structure, comprises an outer foot pad, a movable buckle, an elastic shock-absorbing block and an inner fixing board, wherein the outer foot pad and the movable buckle are sequentially placed in a groove of a main housing, the outer food pad is firmly attached to the movable buckle, and the movable buckle is flexibly fasten to the inner fixing plate, the elastic shock-absorbing block is installed between the movable buckle and the inner fixing plate, and the inner fixing plate is set inside the main housing; and when the movable buckle approaches the inner fixing plate, the elastic shock-absorbing block is squeezed.

Preferably, the outer foot pad is glued with the movable buckle.

Preferably, the outer foot pad comprises a silicone pad.

Preferably, both sides of the movable buckle are provided with hooks, both sides of the inner fixing plate are provided with grooves and limit strips, and the hooks penetrate into the grooves and block the limit strips.

Preferably, the elastic shock-absorbing block comprises sponges.

A keyboard comprises the cushioning foot pad as mentioned above.

The present invention has following beneficial effects:
when the cushioning foot pad structure of the present invention is in use, once the outer foot pad is in rigid contact with a placement surface, the outer foot pad drives the movable buckle to move, and the movable buckle moves closer to the inner fixing plate and squeezes the elastic shock-absorbing block, the elastic shock-absorbing block cushions the force of the rigid surface on a product, moreover, the movement of the movable buckle adjusts a protruding position of the outer foot pad, which can ensure that items using the structure of the present invention can be placed horizontally on uneven placement surfaces. Therefore, the present invention has a wide range of uses and can be used on keyboards, hand rests, tables, chairs, furniture and other objects that need to be placed horizontally.

### BRIEF DESCRIPTION OF THE DRAWINGS

FIG. 1 is a perspective view of a cushioning foot pad structure of the present invention;

FIG. 2 is a structural cross-sectional view of the cushioning foot pad structure of the present invention;

FIG. 3 is an exploded view of the cushioning foot pad structure of the present invention; and

FIG. 4 is a perspective view of the cushioning foot pad structure of the present invention when applied to a keyboard.

### SPECIFIC EMBODIMENTS

The specific embodiments of the present invention will be further described below in conjunction with the accompanying drawings. In the description of the present invention, it should be noted that the orientation or position relationship indicated by the terms “center”, “up”, “down”, “left”, “right”, “vertical”, “horizontal”, “inside”, “outside”, etc., is based on the orientation or position relationship shown in the attached figures, only for the purpose of facilitating the description of the present invention and simplifying the description. It is not indicated or implied that the position or element referred to must have a specific orientation, construction and operation in a specific orientation, and therefore cannot be understood as a limitation of the present invention.

In the description of the present invention, it needs to be noted that, unless otherwise expressly specified and limited, the terms “installation”, “connection” and “connection” shall be broadly understood, for example, it can be a fixed connection, a detachable connection, or an integral connection; it can be a mechanical connection, or it can also be an electrical connection; It can be directly connected, or it can be indirectly connected through an intermediate medium, and it can be the connection between the two components. For ordinary technical personnel in the field, the specific meaning of the above terms in the present invention can be understood according to the specific circumstances

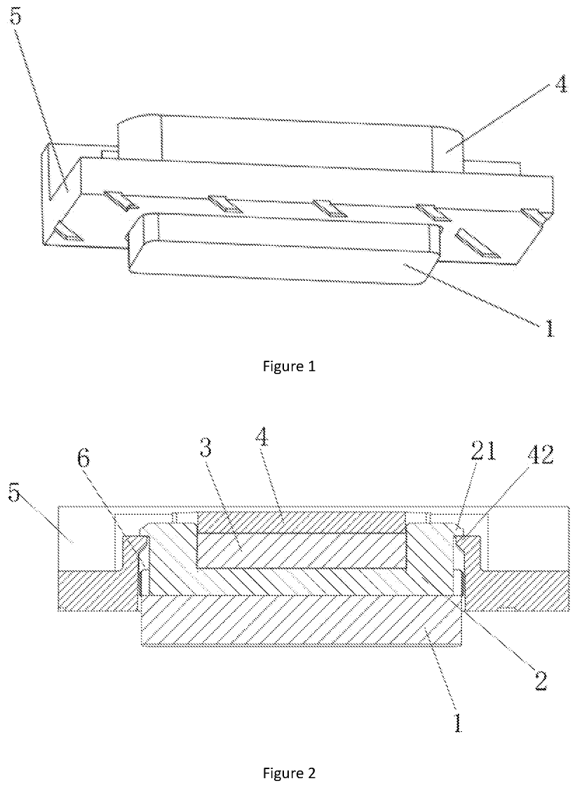

As shown in FIGS. 1-3, a cushioning foot pad structure, comprising an outer foot pad 1, a movable buckle 2, an elastic shock-absorbing block 3 and an inner fixing board 4, wherein the outer foot pad 1 and the movable buckle 2 are sequentially placed in a groove 6 of a main housing 5, tail portions of the outer foot pad 1 are exposed, the outer food pad 1 is firmly attached to the movable buckle 2, and the movable buckle 2 is flexibly fasten to the inner fixing plate 4, the elastic shock-absorbing block 3 is installed between the movable buckle 2 and the inner fixing plate 4, and the inner fixing plate 4 is set inside the main housing 5; and when the movable buckle 2 approaches the inner fixing plate 4, the elastic shock-absorbing block 3 is squeezed.

Specifically, the outer foot pad 1 is glued with the movable buckle 2 and the outer foot pad 1 comprises a silicone pad.

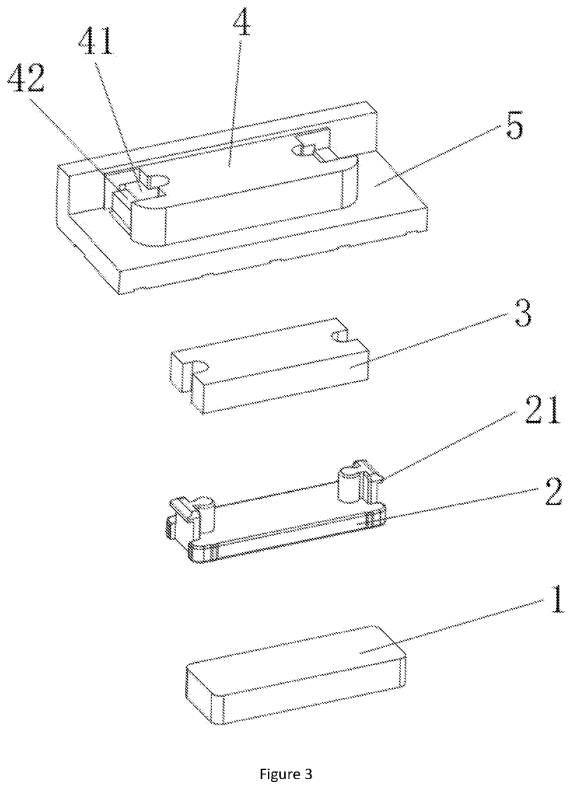

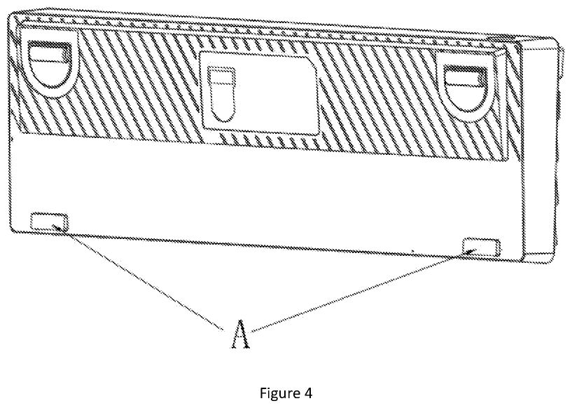

As shown in FIG. 3, both sides of the movable buckle 2 are provided with hooks 21, both sides of the inner fixing plate 4 are provided with grooves 41 and limit strips 42, positions of the grooves 41 and limit strips 42 correspond to positions of the hooks, and the hooks 21 penetrate into the grooves 41 and block the limit strips 42; and when the movable buckle 2 moves upward, the hooks 21 no longer directly contacts the limit strips 42 and move in the grooves 41, due to a position of the inner fixing plate 4 is fixed, a plate portion of the movable buckle 21 compresses the elastic shock-absorbing block 3, and the elastic shock-absorbing block 3 preferably comprises sponges which have large deformation and good shock-absorbing effect.

As shown in FIG. 4, a keyboard is equipped with the cushioning foot pad structures A as mentioned above and the two sets of the cushioning foot pad structures A are arranged on bottom portions of the keyboard.

The above content is a further detailed description of the present invention in combination with specific preferred embodiments. It cannot be concluded that the specific embodiments of the present invention is limited to these descriptions. For those of ordinary skill in the technical field to which the present invention belongs, there is no need to deviate from the present invention. Under the premise of the invention concept, some simple deductions or substitutions can also be made, which should be regarded as belonging to the protection scope of the present invention.

1. A cushioning foot pad structure, comprising an outer foot pad, a movable buckle, an elastic shock-absorbing block and an inner fixing board, wherein the outer foot pad and the movable buckle are sequentially placed in a groove of a main housing, the outer food pad is firmly attached to the movable buckle, and the movable buckle is flexibly fasten to the inner fixing plate, the elastic shock-absorbing block is installed between the movable buckle and the inner fixing plate, and the inner fixing plate is set inside the main housing; and when the movable buckle approaches the inner fixing plate, the elastic shock-absorbing block is squeezed.

2. The cushioning foot pad structure according to claim 1, wherein the outer foot pad is glued with the movable buckle.

3. The cushioning foot pad structure according to claim 1, wherein the outer foot pad comprises a silicone pad.

4. The cushioning foot pad structure according to claim 1, wherein both sides of the movable buckle are provided with hooks, both sides of the inner fixing plate are provided with grooves and limit strips, and the hooks penetrate into the grooves and block the limit strips.

5. The cushioning foot pad structure according to claim 1, wherein the elastic shock-absorbing block comprises sponges.

6. A keyboard comprising the cushioning foot pad according to claim 1.

7. The cushioning foot pad structure according to claim 2, wherein the outer foot pad comprises a silicone pad.

8. A keyboard comprising the cushioning foot pad according to claim 2.

9. A keyboard comprising the cushioning foot pad according to claim 3.

10. A keyboard comprising the cushioning foot pad according to claim 4.

11. A keyboard comprising the cushioning foot pad according to claim 5.
